(19) United States
(12) Patent Application Publication
(10) Pub. No.: US 2025/0030834 A1
(43) Pub. Date: Jan. 23, 2025

(54) METHOD AND DEVICE FOR PICTURE ENCODING AND DECODING

(71) Applicant: InterDigital CE Patent Holdings, SAS, Paris (FR)

(72) Inventors: Franck Galpin, Thorigne-Fouillard (FR); Karam Naser, Mouaze (FR); Antoine Robert, Mezieres sur Couesnon (FR); Philippe Bordes, Laille (FR)

(21) Appl. No.: 18/712,898

(22) PCT Filed: Nov. 15, 2022
(86) PCT No.: PCT/EP2022/081955

§ 371 Date: May 23, 2024

(30) Foreign Application Priority Data
Nov. 25, 2021 (EP) 21306645.9

(51) Int. Cl. H04N 19/105; H04N 19/137; H04N 19/176

(52) U.S. Cl. CPC H04N 19/105; H04N 19/137; H04N 19/176

(57) ABSTRACT

A method for decoding. the method comprising: obtaining an ordered list of a plurality of positions in a spatial neighborhood of a current block in a picture; parsing the list in order until first motion information is available at one of the positions and second motion information is available at a position in a reference picture designated by the first motion information; using the second motion information to obtain at least one motion vector predictor candidate to be inserted in at least one list of motion vector predictor candidates used for predicting a motion vector used for the current block.

### 1. TECHNICAL FIELD

At least one of the present embodiments generally relates to a method and a device for picture encoding and decoding, and more particularly, to a method and a device for encoding and decoding information representative of motion in pictures.

### 2. BACKGROUND ART

To achieve high compression efficiency, video coding schemes usually employ predictions and transforms to leverage spatial and temporal redundancies in a video content. During an encoding, pictures of the video content are divided into blocks of pixels, these blocks being then partitioned into one or more sub-blocks, called original sub-blocks in the following. An intra or inter prediction is then applied to each sub-block to exploit intra or inter picture correlations. Whatever the prediction method used (intra or inter), a predictor sub-block is determined for each original sub-block. Then, a sub-block representing a difference between the original sub-block and the predictor sub-block, often denoted as a prediction error sub-block, a prediction residual sub-block or simply a residual block, is transformed, quantized and entropy coded to generate an encoded video stream. To reconstruct the video, the compressed data is decoded by inverse processes corresponding to the transform, quantization and entropic coding

Basically, a sub-block encoded using inter prediction, i.e. a sub-block encoded using an inter mode, is represented by a residual sub-block and a motion information indicating where finding a predictor sub-block. In the last generations of video compression standards (for example in VVC (ISO/IEC 23090-3-MPEG-I, Versatile Video Coding/ITU-T H.266) or in the standard HEVC (ISO/IEC 23008-2-MPEG-H Part 2, High Efficiency Video Coding/ITU-T H.265)), compression gains were obtained by predicting not only the texture of sub-blocks but also the motion information.

Motion information prediction is mainly based on the assumption that the motion of a sub-block is generally correlated to the motion of other sub-blocks located in its neighborhood. The definition of a neighborhood of a sub-block is therefore a key point of the motion information prediction. Indeed, this neighborhood should be sufficiently large to insure the best possible motion information predictor is in this neighborhood, but without being too large to limit a cost of signaling said motion information predictor.

It is desirable to propose solutions allowing improving the motion information prediction, i.e. insuring that the used neighborhood comprises the best candidates for motion information prediction.

### 3. BRIEF SUMMARY

In a first aspect, one or more of the present embodiments provide a method for decoding, the method comprising:
obtaining an ordered list of a plurality of positions in a spatial neighborhood of a current block in a picture;
parsing the list in order until first motion information is available at one of the positions and second motion information is available at a position in a reference picture designated by the first motion information; and,
using the second motion information to obtain at least one motion vector predictor candidate to be inserted in at least one list of motion vector predictor candidates used for predicting a motion vector used for the current block.

In a second aspect, one or more of the present embodiments provide a method for coding, the method comprising:
obtaining an ordered list of a plurality of positions in a spatial neighborhood of a current block in a picture;
parsing the list in order until first motion information is available at one of the positions and second motion information is available at a position in a reference picture designated by the first motion information; and,
using the second motion information to obtain at least one motion vector predictor candidate to be inserted in at least one list of motion vector predictor candidates used for predicting a motion vector used for the current block.

In an embodiment of the first or the second aspect, the list of a plurality of positions comprises at least two positions among:
a first position at a bottom left corner of the current block;
a second position at a bottom left corner of the current block above the first position;
a third position at a upper right corner of the current block;
a fourth position at a upper right corner of the current block on the left of the fourth position;
a fifth position at a upper left corner of the current block;
a sixth position at a bottom right corner of the current block;

In an embodiment of the first or the second aspect, the second position is before the fourth position in the ordered list of a plurality of positions.

In an embodiment of the first or the second aspect, the second motion information is used to obtain one motion vector predictor candidate to be inserted in one list of motion vector predictor candidates for predicting a motion vector of the current block for the merge mode or for the Advanced Motion Vector Prediction mode.

In an embodiment of the first or the second aspect, the second motion information is used to determine a displacement to be applied to a position of the current block to obtain a motion vector predictor candidate from the reference picture for each sub-block of the current block, the motion vector predictor candidate of a sub-block being inserted in a list of motion vector predictor candidates of the sub-block used for predicting a motion vector of the sub-block.

In an embodiment of the first or the second aspect, if one motion vector predictor candidate of one of the at least one list of motion vector predictor candidates used for predicting a motion vector used for the current block is a bi-prediction candidate, the method comprises discarding either a motion information of this candidate corresponding to a first list of reference pictures or a motion information of this candidate corresponding to a second list of reference pictures and inserting a candidate resulting from this discarding in the list of motion vector predictor candidates.

In an embodiment of the first or the second aspect, the method comprises using at least one position of the list of a plurality of positions to extract a third motion information from the reference picture; deriving a symmetric motion vector predictor from the third motion information, a symmetric motion vector predictor having a first motion vector pointing on a first reference picture and a second motion vector pointing on a second reference picture, the first and the second reference picture being symmetric with respect to the picture comprising the current block, a sum of the first and the second motion vectors being null; and,
inserting the derived symmetric motion vector predictor in the list of motion vector predictor candidates for the current block.

In an embodiment of the first or the second aspect, the method comprises:
displacing the current block from a displacement depending on a motion information obtained from one position of the ordered list of a plurality of positions;
dividing the displaced current block and a co-located block of the reference picture in sub-blocks and for at least one sub-block of the displaced current block, deriving a symmetric motion vector predictor from a motion information of a co-located sub-block of the reference picture, a symmetric motion vector predictor having a first motion vector pointing on a first reference picture and a second motion vector pointing on a second reference picture, the first and the second reference picture being symmetric with respect to the picture comprising the current block, a sum of the first and the second motion vectors being null; and,
inserting the derived symmetric motion vector predictor in the list of motion vector predictor candidates for the sub-block.

In an embodiment of the first or the second aspect, using the second motion information to obtain at least one motion vector predictor candidate to be inserted in at least one list of motion vector predictor candidates used for predicting a motion vector used for the current block comprises, responsive to the second motion information comprising first motion data related to a first list of reference pictures and second motion data related to a second list of reference pictures, using either the first motion data or the second motion data to obtain at least one motion vector predictor candidate to be inserted in at least one list of motion vector predictor candidates used for predicting a motion vector used for the current block.

In an embodiment of the first or the second aspect, the first motion data designates a second reference picture and the second motion data designates a third reference picture and the motion information among the first motion data and the second motion data designating the reference picture among the first reference picture and the second reference picture the closest to the picture comprising the current block in terms of picture order count is used.

In an embodiment of the first or the second aspect, at list one motion vector predictor derived using a projected buffer is inserted in at least one list of motion vector predictor candidates used for predicting the motion vector used for the current block.

In a third aspect, one or more of the present embodiments provide a device for decoding, the device comprising electronic circuitry configured for:
obtaining an ordered list of a plurality of positions in a spatial neighborhood of a current block in a picture;
parsing the list in order until first motion information is available at one of the positions and second motion information is available at a position in a reference picture designated by the first motion information; and,
using the second motion information to obtain at least one motion vector predictor candidate to be inserted in at least one list of motion vector predictor candidates used for predicting a motion vector used for the current block.

In a fourth aspect, one or more of the present embodiments provide a device for coding, the device comprising electronic circuitry configured for:
obtaining an ordered list of a plurality of positions in a spatial neighborhood of a current block in a picture;
parsing the list in order until first motion information is available at one of the positions and second motion information is available at a position in a reference picture designated by the first motion information; and,
using the second motion information to obtain at least one motion vector predictor candidate to be inserted in at least one list of motion vector predictor candidates used for predicting a motion vector used for the current block.

In one embodiment of the third or the fourth aspect, the list of a plurality of positions comprises at least two positions among:
a first position at a bottom left corner of the current block;
a second position at a bottom left corner of the current block above the first position;
a third position at a upper right corner of the current block;
a fourth position at a upper right corner of the current block on the left of the fourth position;
a fifth position at a upper left corner of the current block;
a sixth position at a bottom right corner of the current block;

In one embodiment of the third or the fourth aspect, the second position is before the fourth position in the ordered list of a plurality of positions.

In one embodiment of the third or the fourth aspect, the second motion information is used to obtain one motion vector predictor candidate to be inserted in one list of motion vector predictor candidates for predicting a motion vector of the current block for the merge mode or for the Advanced Motion Vector Prediction mode.

In one embodiment of the third or the fourth aspect, the second motion information is used to determine a displacement to be applied to a position of the current block to obtain a motion vector predictor candidate from the reference picture for each sub-block of the current block, the motion vector predictor candidate of a sub-block being inserted in a list of motion vector predictor candidates of the sub-block used for predicting a motion vector of the sub-block.

In one embodiment of the third or the fourth aspect, the electronic circuitry is further configured for, responsive to one motion vector predictor candidate of one of the at least one list of motion vector predictor candidates used for predicting a motion vector used for the current block being a bi-prediction candidate, discarding either a motion information of this candidate corresponding to a first list of reference pictures or a motion information of this candidate corresponding to a second list of reference pictures and inserting a candidate resulting from this discarding in the list of motion vector predictor candidates.

In one embodiment of the third or the fourth aspect, the electronic circuitry is further configured for:
using at least one position of the list of a plurality of positions to extract a third motion information from the reference picture;
deriving a symmetric motion vector predictor from the third motion information, a symmetric motion vector predictor having a first motion vector pointing on a first reference picture and a second motion vector pointing on a second reference picture, the first and the second reference picture being symmetric with respect to the picture comprising the current block, a sum of the first and the second motion vectors being null; and,
inserting the derived symmetric motion vector predictor in the list of motion vector predictor candidates for the current block.

In one embodiment of the third or the fourth aspect, the electronic circuitry is further configured for:
displacing the current block from a displacement depending on a motion information obtained from one position of the ordered list of a plurality of positions;
dividing the displaced current block and a co-located block of the reference picture in sub-blocks and for at least one sub-block of the displaced current block, deriving a symmetric motion vector predictor from a motion information of a co-located sub-block of the reference picture, a symmetric motion vector predictor having a first motion vector pointing on a first reference picture and a second motion vector pointing on a second reference picture, the first and the second reference picture being symmetric with respect to the picture comprising the current block, a sum of the first and the second motion vectors being null; and
inserting the derived symmetric motion vector predictor in the list of motion vector predictor candidates for the sub-block.

In one embodiment of the third or the fourth aspect, using the second motion information to obtain at least one motion vector predictor candidate to be inserted in at least one list of motion vector predictor candidates used for predicting a motion vector used for the current block comprises, responsive to the second motion information comprising first motion data related to a first list of reference pictures and second motion data related to a second list of reference pictures, using either the first motion data or the second motion data to obtain at least one motion vector predictor candidate to be inserted in at least one list of motion vector predictor candidates used for predicting a motion vector used for the current block.

In one embodiment of the third or the fourth aspect, the first motion data designates a second reference picture and the second motion data designates a third reference picture; and wherein, the motion information among the first motion data and the second motion data designating the reference picture among the first reference picture and the second reference picture the closest to the picture comprising the current block in terms of picture order count is used.

In one embodiment of the third or the fourth aspect, the electronic circuitry is further configured to insert at list one motion vector predictor derived using a projected buffer in at least one list of motion vector predictor candidates used for predicting the motion vector used for the current block.

In a fifth aspect, one or more of the present embodiments provide a signal generated by the method of the second aspect or by the device of the fourth aspect.

In a sixth aspect, one or more of the present embodiments provide a computer program comprising program code instructions for implementing the method according to the first or the second aspect.

In a seventh aspect, one or more of the present embodiments provide a non-transitory information storage medium storing program code instructions for implementing the method according to the first or the second aspect.

### 4. BRIEF SUMMARY OF THE DRAWINGS

FIG. 1 illustrates an example of partitioning undergone by an image of pixels of an original video;

FIG. 2 depicts schematically a method for encoding a video stream executed by an encoding module;

FIG. 3 depicts schematically a method for decoding the encoded video stream (i.e. the bitstream);

FIG. 4A illustrates schematically an example of hardware architecture of a processing module able to implement an encoding module or a decoding module in which various aspects and embodiments are implemented;

FIG. 4B illustrates a block diagram of an example of a system in which various aspects and embodiments are implemented;

FIG. 5 represents a position of the temporal motion vector predictor of the list of candidates of the regular merge mode;

FIG. 6 represents a motion vector scaling of the temporal motion vector predictor of the list of candidates of the regular merge mode;

FIG. 7 represents the spatially neighboring blocks considered in the sub-block temporal motion vector prediction process;

FIG. 8 illustrates an example of a process allowing deriving the sub-block temporal motion vector predictor;

FIG. 9 illustrates schematically a symmetric motion vector difference mode;

FIG. 10 illustrates new positions allowing deriving a temporal motion vector predictor and a sub-block temporal motion vector predictor;

FIG. 11 illustrates a process allowing defining symmetric temporal motion vector candidates; and,

FIG. 12 illustrates schematically a process for improving a temporal candidate for Advanced Motion Vector Prediction (AMVP).

### 5. DETAILED DESCRIPTION

In the following description, some embodiments use tools developed in the context of VVC or in the context of HEVC. However, these embodiments are not limited to the video coding/decoding method corresponding to VVC or HEVC, and applies to other video coding/decoding methods such as AVC ((ISO/CEI 14496-10), EVC (Essential Video Coding/MPEG-5), AV1 and VP9 but also to any method in which a picture is predicted from another picture.

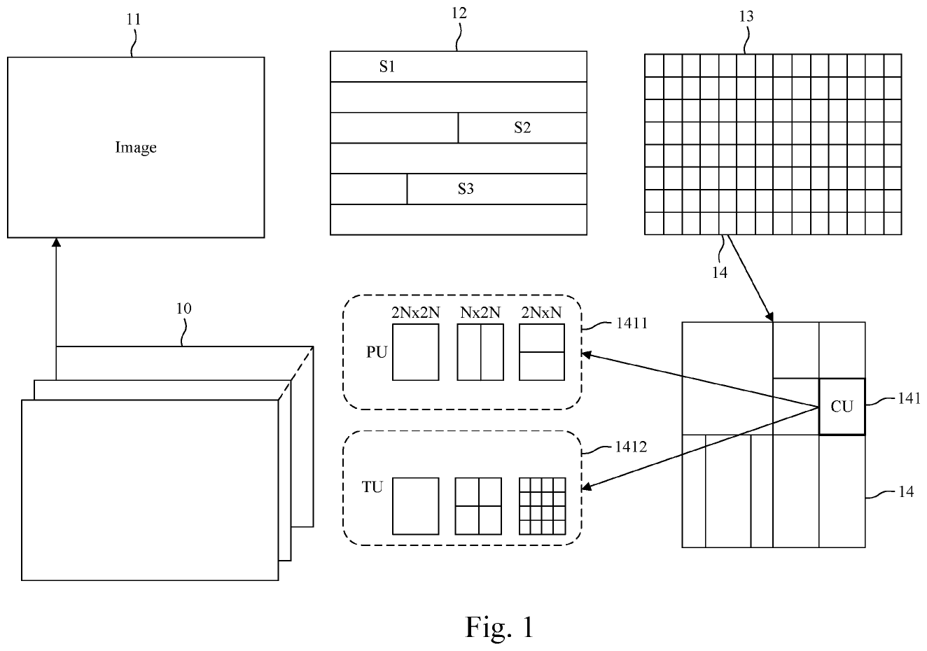

FIG. 1 illustrates an example of partitioning undergone by a picture of pixels 11 of an original video 10. It is considered here that a pixel is composed of three components: a luminance component and two chrominance components. However, the following embodiments are adapted to pictures constituted of pixels comprising another number of components, for instance grey level pictures wherein pixels comprise one component, or pictures constituted of pixels comprising three color components and a transparency component and/or a depth component.

A picture is divided in a plurality of coding entities. First, as represented by reference 13 in FIG. 1, a picture is divided in a grid of blocks called coding tree units (CTU). A CTU consists of an N×N block of luminance samples together with two corresponding blocks of chrominance samples. N is in general a power of two having, for example, a maximum value of “128”. Second, a picture is divided into one or more groups of CTU. For example, it can be divided into one or more tile rows and tile columns, a tile being a sequence of CTU covering a rectangular region of a picture. In some cases, a tile could be divided into one or more bricks, each of which consisting of at least one row of CTU within the tile. Above the concept of tiles and bricks, another encoding entity, called slice, exists, that can contain at least one tile of a picture or at least one brick of a tile.

In the example in FIG. 1, as represented by reference 12, the picture 11 is divided into three slices S1, S2 and S3, each comprising a plurality of tiles (not represented).

As represented by reference 14 in FIG. 1, a CTU may be partitioned in the form of a hierarchical tree of one or more sub-blocks called coding units (CU). The CTU is the root (i.e. the parent node) of the hierarchical tree and can be partitioned in a plurality of CU (i.e. child nodes). Each CU becomes a leaf of the hierarchical tree if it is not further partitioned in smaller CU or becomes a parent node of smaller CU (i.e. child nodes) if it is further partitioned. Several types of hierarchical trees can be applied comprising for example a quadtree, a binary tree and a ternary tree. In a quadtree, a CTU (respectively a CU) can be partitioned in (i.e. can be the parent node of) “4” square CU of equal sizes. In a binary tree, a CTU (respectively a CU) can be partitioned horizontally or vertically in “2” rectangular CU of equal sizes. In a ternary tree, a CTU (respectively a CU) can be partitioned horizontally or vertically in “3” rectangular CU. For example, a CU of height N and width M is vertically (respectively horizontally) partitioned in a first CU of height N (resp. N/4) and width M/4 (resp. M), a second CU of height N (resp. N/2) and width M/2 (resp. M), and a third CU of height N (resp. N/4) and width M/4 (resp. M).

In the example of FIG. 1, the CTU 14 is first partitioned in “4” square CU using a quadtree type partitioning. The upper left CU is a leaf of the hierarchical tree since it is not further partitioned, i.e. it is not a parent node of any other CU. The upper right CU is further partitioned in “4” smaller square CU using again a quadtree type partitioning. The bottom right CU is vertically partitioned in “2” rectangular CU using a binary tree type partitioning. The bottom left CU is vertically partitioned in “3” rectangular CU using a ternary tree type partitioning.

During the coding of a picture, the partitioning is adaptive, each CTU being partitioned in order to optimize a compression efficiency of the CTU criterion.

In some compression method appeared concepts of prediction unit (PU) and transform unit (TU). In that case, the coding entity that is used for prediction (i.e. a PU) and transform (i.e. a TU) can be a subdivision of a CU. For example, as represented in FIG. 1, a CU of size 2N×2N, can be divided in PU 1411 of size N×2N or of size 2N×N. In addition, said CU can be divided in “4” TU 1412 of size N×N or in “16” TU of size (N/2)×(N/2).

In the present application, the term “block” or “picture block” or “sub-block” can be used to refer to any one of a CTU, a CU, a PU and a TU. In addition, the term “block” or “picture block” can be used to refer to a macroblock, a partition and a sub-block as specified in H.264/AVC or in other video coding standards, and more generally to refer to an array of samples of numerous sizes.

In the present application, the terms “pixel” and “sample” may be used interchangeably, the terms “image,” “picture”, “frame”, “sub-picture”, “slice” and “frame” may be used interchangeably.

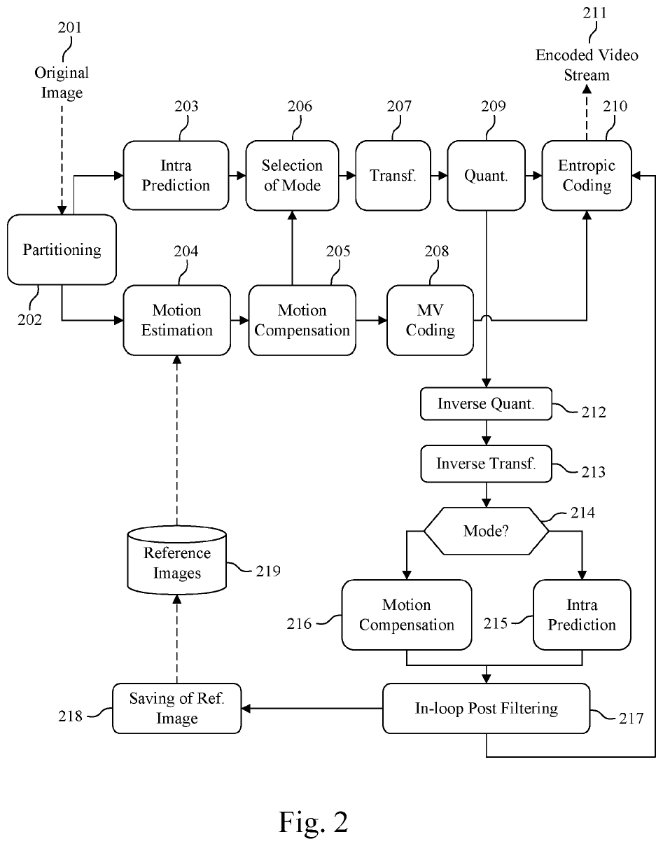

FIG. 2 depicts schematically a method for encoding a video stream executed by an encoding module. Variations of this method for encoding are contemplated, but the method for encoding of FIG. 2 is described below for purposes of clarity without describing all expected variations.

The encoding of a current original picture 201 begins with a partitioning of the current original picture 201 during a step 202, as described in relation to FIG. 1. The current image 201 is thus partitioned into CTU, CU, PU, TU, etc. For each block, the encoding module determines a coding mode between an intra prediction and an inter prediction.

The intra prediction, represented by step 203, consists of predicting, in accordance with an intra prediction method, the pixels of a current block from a prediction block derived from pixels of reconstructed blocks situated in a causal vicinity of the current block to be coded. The result of the intra prediction is a prediction direction indicating which pixels of the blocks in the vicinity to use, and a residual block resulting from a calculation of a difference between the current block and the prediction block.

The inter prediction consists of predicting the pixels of a current block from a block of pixels, referred to as the reference block, of a picture preceding or following the current picture, this picture being referred to as the reference picture. During the coding of a current block in accordance with the inter prediction method, a block of the reference picture closest, in accordance with a similarity criterion, to the current block is determined by a motion estimation step 204. During step 204, a motion vector indicating the position of the reference block in the reference picture is determined. Said motion vector is used during a motion compensation step 205 during which a residual block is calculated in the form of a difference between the current block and the reference block.

In the first video compression standards, the mono-directional inter prediction mode described above was the only inter mode available. As video compression standards evolved, the family of inter modes has grown significantly and comprises now many different inter modes.

During a selection step 206, the prediction mode optimizing the compression performances, in accordance with a rate/distortion criterion (i.e. RDO criterion), among the prediction modes tested (Intra prediction modes, Inter prediction modes) is selected by the encoding module.

When the prediction mode is selected, the residual block is transformed during a step 207 and quantized during a step 209. Note that the encoding module can skip the transform and apply quantization directly to the non-transformed residual signal.

When the current block is coded according to an intra prediction mode, a prediction direction and the transformed and quantized residual block are encoded by an entropic encoder during a step 210.

When the current block is encoded according to an inter prediction mode, the motion data associated with this inter prediction mode are coded in a step 208.

In general, two modes can be used to encode the motion data, respectively called AMVP (Advanced Motion Vector Prediction) and Merge.

AMVP basically consists in signaling a reference picture(s) (i.e. an index of the reference picture in a list of reference pictures between a list list-0 and a list list-1) used to predict a current block, a motion vector predictor index and a motion vector difference (also called motion vector residual). Lists list-0 and list-1 are two different lists of reference pictures.

The merge mode consists in signaling an index of some motion data collected in a list of motion data predictors. The list is made of “5” or “7” motion vector candidates and is constructed the same way on the encoder and decoder sides. Therefore, the merge mode aims at deriving some motion data taken from the merge list. The merge list typically contains motion data associated to some spatially and temporally neighboring blocks, available in their reconstructed state when the current block is being processed. The merge mode can take several forms comprising a regular merge mode and a sub-block merge mode. The list of candidates of each of these two merge modes comprises a temporal motion vector predictor (TMVP).

In the following, we use indifferently the term motion data, motion information or motion vector. Hence, the term motion vector covers either all information representative of the motion of a block, comprising at least one index representative of one reference picture and a motion vector represented by an index representative of a motion vector predictor and a difference between the motion vector predictor and the predicted motion vector, or covers only the motion vector.

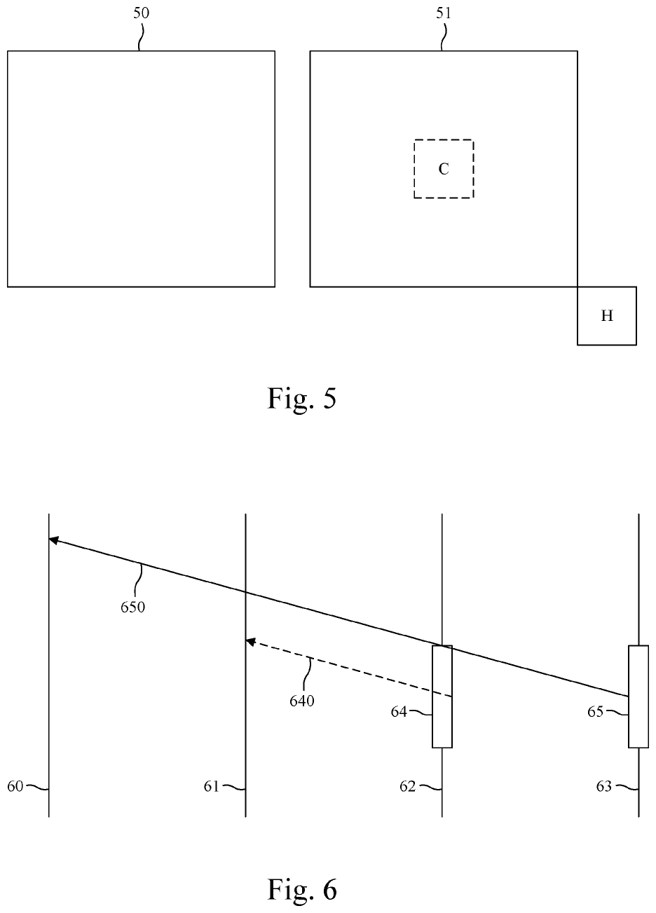

FIG. 5 represents a position of a temporal motion vector predictor, called regular temporal motion vector predictor (RTMVP) in the following, of the list of candidates of the regular merge mode. The RTMVP is derived from a motion vector corresponding to a position H located at a bottom right corner of a block 51 collocated with the current block 50. If no motion data are available at position H, the RTMVP is derived from the motion data at a central position C of the collocated block 51. The block 51 belongs to a particular reference image signaled in a slice header called collocated image. The RTMVP is then obtained by rescaling the obtained motion vector so that the rescaled motion vector points on a reference image in first position in a reference image buffer (also called decoded picture buffer in the following with reference 219).

FIG. 6 represents a motion vector scaling of the temporal motion vector predictor of the list of candidates of the regular merge mode.

In FIG. 6, a current picture 62 comprises a current block 64 to encode. The motion data of the current block 64 are encoded in regular merge mode using the motion data of a collocated block 65 in a collocated picture 63. The motion data of the collocated block 65 comprise a motion vector 650 pointing to an area in a reference picture 60. The RTMVP, corresponding to a motion vector 640, is obtained by rescaling the motion vector 650. As can be noted, the RTMVP 640 has the same direction than the motion vector 650 but points to a reference area in a picture 61. Picture 61 is the first picture in the decoded picture buffer 219.

The sub-block merge mode uses a sub-block temporal motion vector prediction to generate a sub-block temporal motion predictor (SbTMVP). The SbTMVP differs from the RTMVP in the following two main aspects:
the RTMVP predicts motion at block level while the SbTMVP predicts motion at sub-block level;
whereas the RTMVP is derived from a collocated block in the collocated picture, the position of the current block is first shifted before deriving the SbTMVP from a block collocated with the shifted position of the current block of the collocated picture. The shift, called motion shift in the following, is obtained from a motion vector of a block spatially neighboring the current block.

FIG. 8 illustrates an example of a process allowing deriving the sub-block temporal motion vector predictor.

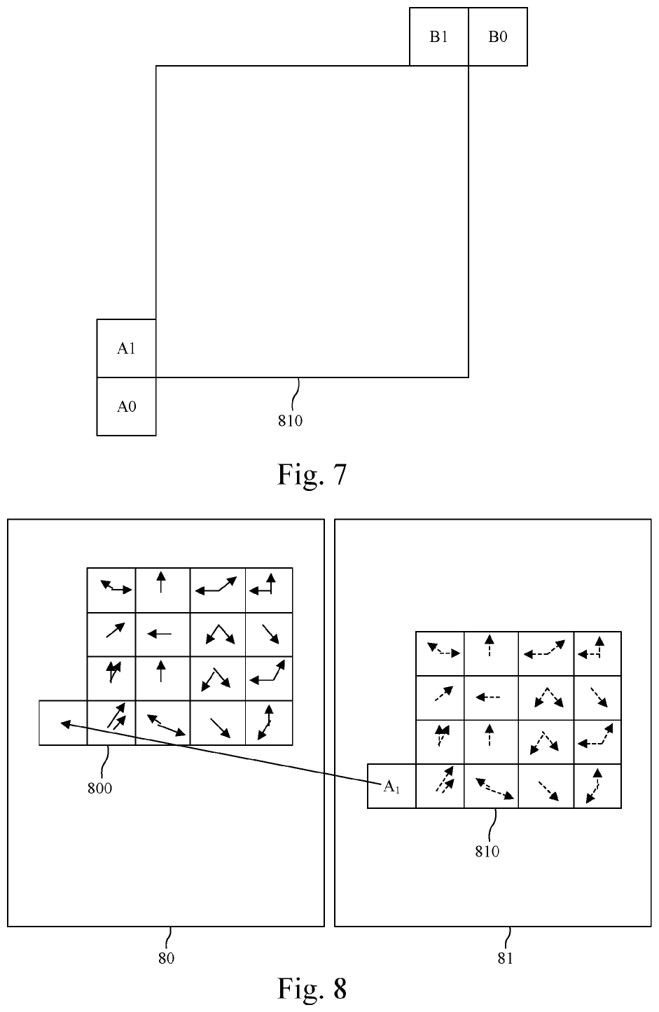

The sub-block motion vector prediction predicts the motion vectors of sub-blocks within a current block 810 of a current picture 81 in two steps:
In the first step, blocks spatially neighboring the current block 810 are examined. FIG. 7 represents the spatially neighboring blocks considered in the sub-block temporal motion vector prediction process. As can be seen in FIG. 7, four blocks are considered, two blocks A1 and A0 located on the bottom left corner of block 810 and two blocks B1, B0 located at the upper right corner of block 810. The spatially neighboring blocks are examined in the order A1, B1, B0 and A0. In this order, as soon as a spatially neighboring block having a motion vector pointing to the collocated picture 80 is identified, this motion vector is selected to be the motion shift to be applied. If no such motion vector is identified from the spatially neighboring blocks A1, B1, B0 and A0, then the motion shift is set to (0, 0), i.e. no motion.
In the second step, the motion shift identified in the first step is applied to the position of the current block 810 (i.e. added to the current block 810 coordinates). Then, sub-block-level motion data (motion vectors and reference indices) are derived from a block 800 of the collocated picture 80 collocated with the shifted position of the current block 810. In the example of FIG. 8, the motion shift is assumed to be set to the motion of block A1. For each sub-block of the current block 810, the motion data of its corresponding sub-block (the smallest motion grid that covers the center sample) in the block 800 is used to derive the motion data for said sub-block of the current block 810. The SbTMVP derivation is then finalized by applying a temporal motion vector scaling to the motion vectors derived for each sub-block to align the reference pictures of these derived motion vectors to that of the current block 810. For each sub-block, the scaled motion vector is used as a motion vector for the sub-block.

The sub-block size used in SbTMVP is generally 8×8. In that case, SbTMVP mode is only applicable to blocks having a width and a height larger than or equal to “8”.

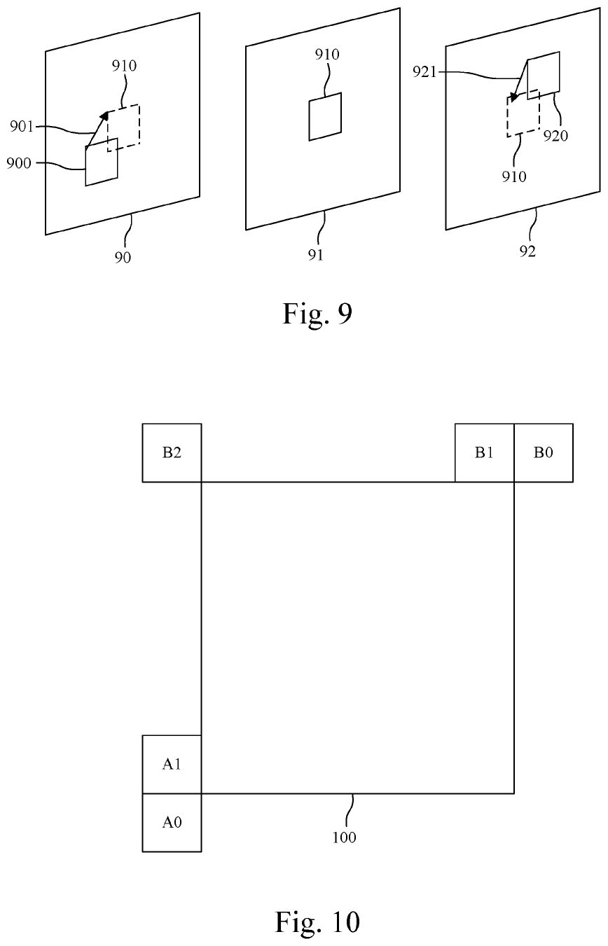

In some implementations, besides the normal unidirectional prediction mode (respectively the bi-prediction mode) motion vector difference (MVD) signaling wherein motion information comprising a reference picture index for one of the list list-0 or list-1 (respectively for both lists list-0 and list-1) and a MVD corresponding to said list (respectively a MVD for each list) are signaled, another mode, called symmetric MVD mode, adapted to bi-prediction MVD signaling can be applied. In the symmetric MVD mode illustrated in FIG. 9, motion vector predictors corresponding to lists list-0 and list-1 and MVD corresponding to list list-0 (called MVD0) are explicitly signaled but reference picture indices in both lists list-0 and list-1 and the MVD corresponding to list list-1 (called MVD1) are not signaled but derived. In FIG. 9, a block at a position 910 in a current picture 91 is predicted from a block of at position 900 in a reference picture 90 in list list-0 and from a block in a reference picture 92 in list list-1. The motion between positions 910 and 900 is reflected by a motion vector 901. The motion between positions 910 and 920 is reflected by a motion vector 921. MVDs used to compute the motion vectors 901 and 921 are symmetric, i.e. the sum of motion vector difference MVD0+MVD1 is null.

The decoding process of the symmetric MVD mode is as follows:
1. At slice level, variables BiDirPredFlag, RefIdxSymL0 and RefIdxSymL1 are derived as follows:
   If a flag mvd_11_zero flag is “1” indicating that the motion vector difference corresponding to list list-1 is equal to zero, BiDirPredFlag is set equal to “0”.
   Otherwise, if the nearest reference picture in list list-0 and the nearest reference picture in list list-1 form a forward and backward pair of reference pictures or a backward and forward pair of reference pictures, BiDirPredFlag is set to “1”, and both reference pictures of lists list-0 and list-1 are short-term reference pictures. Otherwise BiDirPredFlag is set to “0”.
2. At CU level, a symmetric MVD mode flag indicating whether symmetric MVD mode is used or not for a CU is explicitly signaled if the CU is bi-prediction coded and BiDirPredFlag is equal to “1”.
When the symmetric MVD mode flag is true, only the syntax elements mvp_10_flag, mvp_11_flag and MVD0 are explicitly signaled. The syntax element mvp_10_flag (respectively mvp_11_flag) specifies the motion vector predictor index of list list-0 (respectively list list-1). The reference indices in lists list-0 and list-1 are set equal to the pair of reference pictures, respectively. MVD1 is set equal to (−MVD0).

As can be seen, a block encoded according to the symmetric MVD mode has a first motion vector pointing on a first reference picture and a second motion vector pointing on a second reference picture. The first and the second reference picture indices are inferred respectively from a content of list list-0 and list list-1, the first motion vector being computed as a sum of a first motion vector predictor signaled by mvp_10_flag and MVD0, the second motion vector being computed as a sum of a second motion vector predictor mvp_11_flag and MVD1, only the first and second motion vector predictors and MVD0 being signaled, MVD1 being inferred from MVD0.

In the encoder, the symmetric MVD mode motion estimation starts with an initial motion vector evaluation. A set of initial motion vector candidates comprising a motion vector obtained by a uni-prediction search, a motion vector obtained by a bi-prediction search and motion vectors from the AMVP list is obtained. The one with the lowest rate-distortion cost is chosen to be the initial motion vector (i.e. the seed motion vector) for the symmetric MVD motion mode search. The motion search is performed by only checking the lowest rate-distortion when searching a motion vector mv0 in the list list-0 and applying a motion vector mv1=−(mv0−mvp0)+mvp1 to the list list-1.

As already mentioned, defining good motion vector candidates is a key aspect for motion vector prediction. One solution allowing defining motion vector candidates consists, before coding a current picture, in computing an interpolated motion field for this picture based on uni-prediction as described in document Algorithm Description of Joint Exploration Test Model 6 (JEM 6)″ JVET-F1001, section 2.3.7.3 available at https://jvet-experts.org/doc_end_user/documents/6_Hobart/wg11/JVET-F1001-v2.zip. The motion field may then be used to generate CU level or sub-CU level motion vector candidates for motion vector prediction. In this solution, reference pictures of both list list-0 and list-1 are traversed in a predefined order. Then the motion field of each reference picture is traversed in a predefined order at a 4×4 block level. For each 4×4 block of a reference picture, if the motion associated to this 4×4 block passes through a 4×4 block of the current picture and the block of the current picture has not been assigned any interpolated motion information, the motion of the 4×4 block of the reference picture is scaled to the current picture (the same way as that of motion vector scaling of TMVP) and the scaled motion is assigned to the 4×4 block of the current picture. If no scaled motion vector is assigned to a 4×4 block of the current picture, the motion of this 4×4 block is marked as unavailable in the interpolated motion field.

Another important aspect, once motion vector candidates to be put in a list of motion vector candidates for motion vector prediction have been defined, is the ordering of the motion vector candidates in the list. In particular, it is important to well define the motion vector candidate in first position in the list since this first motion vector candidate is generally associated to the lowest encoding cost. This first motion vector candidate is generally called the initial seed.

It has been observed that temporal displaced motion vector candidates (such as the one used in SbTMVP) doesn't provide a good initial seed.

Independently of the initial seed, it has been also observed that extracted motion information after rescaling might not be the best choice of rescaling. Smaller motion vectors after rescaling and symmetrical w.r.t. current frame might offer better motion information.

Once predicted, the motion information is next encoded by the entropic encoder during step 210, along with transformed and quantized residual block. Note that the encoding module can bypass both transform and quantization, i.e., the entropic encoding is applied on the residual without the application of the transform or quantization processes. The result of the entropic encoding is inserted in an encoded video stream (i.e. a bitstream) 211.

Note that the entropic encoder can be implemented in a form of a context adaptive binary arithmetic coder (CABAC). CABAC encodes binary symbols, which keeps the complexity low and allows probability modelling for more frequently used bits of any symbol.

After the quantization step 209, the current block is reconstructed so that the pixels corresponding to that block can be used for future predictions. This reconstruction phase is also referred to as a prediction loop. An inverse quantization is therefore applied to the transformed and quantized residual block during a step 212 and an inverse transformation is applied during a step 213. According to the prediction mode used for the current block obtained during a step 214, the prediction block of the current block is reconstructed. If the current block is encoded according to an inter prediction mode, the encoding module applies, when appropriate, during a step 216, a motion compensation to a reference block using the motion information of the current block. If the current block is encoded according to an intra prediction mode, during a step 215, the prediction direction corresponding to the current block is used for reconstructing the reference block of the current block. The reference block and the reconstructed residual block are added in order to obtain the reconstructed current block.

Following the reconstruction, a post-filtering intended to reduce the encoding artefacts is applied, during a step 217, to the reconstructed block. This post-filtering is called in-loop post-filtering since this post-filtering occurs in the prediction loop to obtain at the encoder the same reference pictures as the decoder and thus avoid a drift between the encoding and the decoding processes. For instance, the in-loop post-filtering comprises a deblocking filtering a SAO (sample adaptive offset) filtering and a ALF (adaptive loop filter) filtering. Parameters representative of the activation or the deactivation of the in-loop deblocking filter and when activated, of characteristics of said in-loop deblocking filter are introduced in the encoded video stream 211 during the entropic coding step 210.

When a block is reconstructed, it is inserted during a step 218 into a reconstructed picture stored in the decoded picture buffer (DPB) 219. The reconstructed pictures thus stored can then serve as reference pictures for other pictures to be coded.

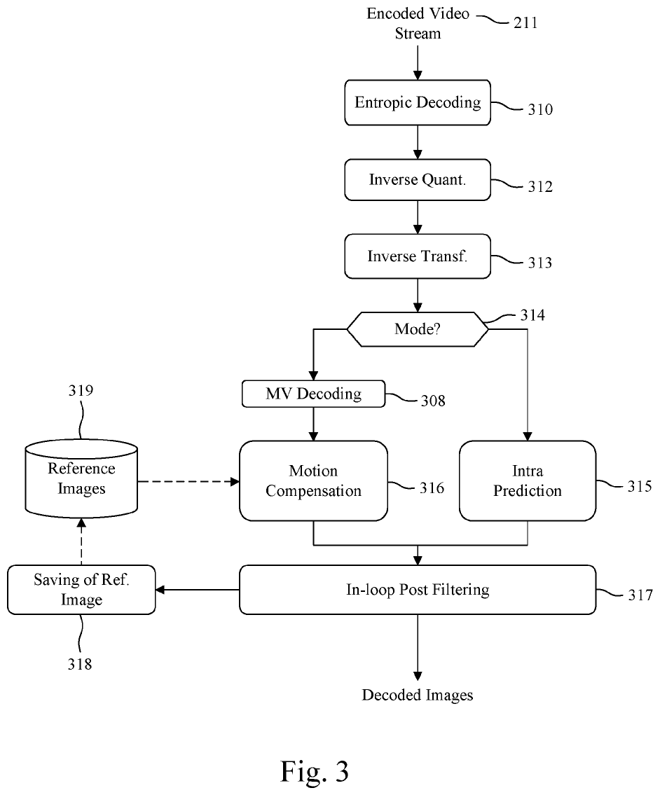

FIG. 3 depicts schematically a method for decoding the encoded video stream (i.e. the bitstream) 211 encoded according to method described in relation to FIG. 2. Said method for decoding is executed by a decoding module. Variations of this method for decoding are contemplated, but the method for decoding of FIG. 3 is described below for purposes of clarity without describing all expected variations.

The decoding is done block by block. For a current block, it starts with an entropic decoding of the current block during a step 310. Entropic decoding allows to obtain the prediction mode of the current block.

If the current block has been encoded according to an intra prediction mode, the entropic decoding allows to obtain, information representative of an intra prediction direction and a residual block.

If the current block has been encoded according to an inter prediction mode, the entropic decoding allows to obtain, information representative of motion data and a residual block. When appropriate, during a step 308, the motion data are reconstructed for the current block according to the AMVP or the merge mode. In the merge mode, the motion data obtained by the entropic decoding comprise an index in a list of motion vector predictor candidates. The decoding module applies the same process than the encoding module to construct the list of candidates for the regular merge mode and a sub-block merge mode. With the reconstructed list and the index, the decoding module is able to retrieve a motion vector used to predict the motion vector of a block.

The method for decoding comprises steps 312, 313, 315, 316 and 317 in all respects identical respectively to steps 212, 213, 215, 216 and 217 of the method for encoding. Whereas at the encoding module level, the step 214 comprises a mode selection process evaluating each mode according to a rate distortion criterion and selecting the best mode, step 314 just consists in reading an information representative of a selected mode in the bitstream 211. Decoded blocks are saved in decoded pictures and the decoded pictures are stored in a DPB 319 in a step 318. When the decoding module decodes a given picture, the pictures stored in the DPB 319 are identical to the pictures stored in the DPB 219 by the encoding module during the encoding of said given picture. The decoded picture can also be outputted by the decoding module for instance to be displayed.

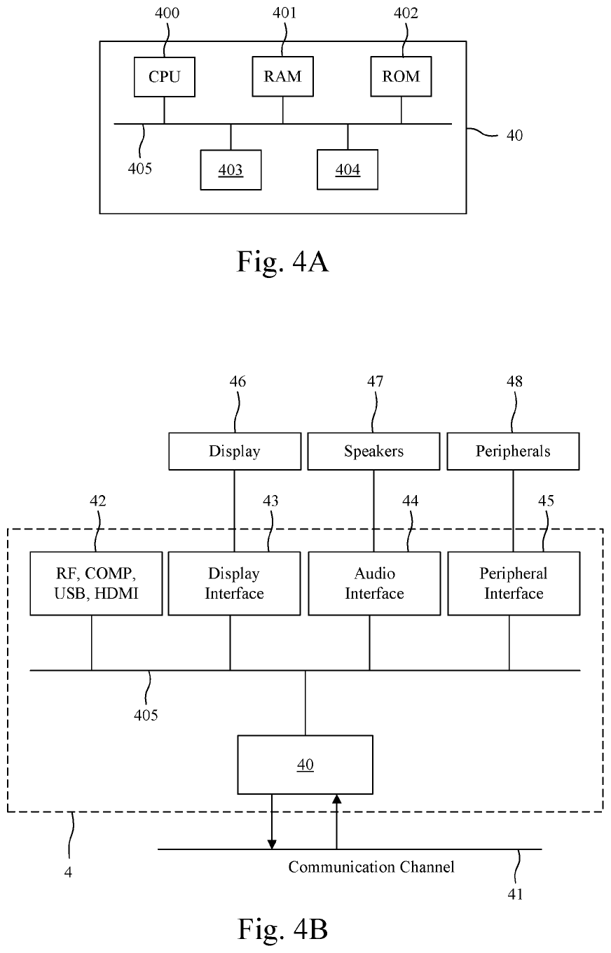

FIG. 4A illustrates schematically an example of hardware architecture of a processing module 40 able to implement an encoding module or a decoding module capable of implementing respectively the method for encoding of FIG. 2 and the method for decoding of FIG. 3 modified according to different aspects and embodiments. The processing module 40 comprises, connected by a communication bus 405: a processor or CPU (central processing unit) 400 encompassing one or more microprocessors, general purpose computers, special purpose computers, and processors based on a multi-core architecture, as non-limiting examples; a random access memory (RAM) 401; a read only memory (ROM) 402; a storage unit 403, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive, or a storage medium reader, such as a SD (secure digital) card reader and/or a hard disc drive (HDD) and/or a network accessible storage device; at least one communication interface 404 for exchanging data with other modules, devices or equipment. The communication interface 404 can include, but is not limited to, a transceiver configured to transmit and to receive data over communication channel. The communication interface 404 can include, but is not limited to, a modem or network card.

If the processing module 40 implements a decoding module, the communication interface 404 enables for instance the processing module 40 to receive an encoded video stream and to provide a decoded video stream. If the processing module 40 implements an encoding module, the communication interface 404 enables for instance the processing module 40 to receive original image data to encode and to provide an encoded video stream representative of these original image data.

The processor 400 is capable of executing instructions loaded into the RAM 401 from the ROM 402, from an external memory (not shown), from a storage medium, or from a communication network. When the processing module 40 is powered up, the processor 400 is capable of reading instructions from the RAM 401 and executing them. These instructions form a computer program causing. for example, the implementation by the processor 400 of a decoding method as described in relation with FIG. 3 or an encoding method described in relation to FIG. 2, the decoding and encoding methods comprising various aspects and embodiments described below in this document.

All or some of the algorithms and steps of said encoding or decoding methods may be implemented in software form by the execution of a set of instructions by a programmable machine such as a DSP (digital signal processor) or a microcontroller, or be implemented in hardware form by a machine or a dedicated component such as a FPGA (field-programmable gate array) or an ASIC (application-specific integrated circuit).

FIG. 4B illustrates a block diagram of an example of a system 4 in which various aspects and embodiments are implemented. System 4 can be embodied as a device including the various components described below and is configured to perform one or more of the aspects and embodiments described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 4, singly or in combination, can be embodied in a single integrated circuit (IC), multiple ICs, and/or discrete components. For example, in at least one embodiment, the system 4 comprises one processing module 40 that implement a decoding module or an encoding module. But, in another embodiment, the system 4 can comprise a first processing module 40 implementing a decoding module and a second processing module 40 implementing an encoding module or one processing module 40 implementing a decoding module and an encoding module. In various embodiments, the system 4 is communicatively coupled to one or more other systems, or other electronic devices, via, for example, a communications bus or through dedicated input and/or output ports. In various embodiments, the system 4 is configured to implement one or more of the aspects described in this document.

The system 4 comprises at least one processing module 40 capable of implementing one of an encoding module or a decoding module or both.

The input to the processing module 40 can be provided through various input modules as indicated in block 42. Such input modules include, but are not limited to, (i) a radio frequency (RF) module that receives an RF signal transmitted, for example, over the air by a broadcaster, (ii) a component (COMP) input module (or a set of COMP input modules), (iii) a Universal Serial Bus (USB) input module, and/or (iv) a High Definition Multimedia Interface (HDMI) input module. Other examples, not shown in FIG. 4B, include composite video.

In various embodiments, the input modules of block 42 have associated respective input processing elements as known in the art. For example, the RF module can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which can be referred to as a channel in certain embodiments, (iv) demodulating the down-converted and band-limited signal. (v) performing error correction, and (vi) demultiplexing to select the desired stream of data packets. The RF module of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. In one set-top box embodiment, the RF module and its associated input processing element receives an RF signal transmitted over a wired (for example, cable) medium, and performs frequency selection by filtering, down-converting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF module includes an antenna.

Additionally, the USB and/or HDMI modules can include respective interface processors for connecting system 4 to other electronic devices across USB and/or HDMI connections. It is to be understood that various aspects of input processing, for example, Reed-Solomon error correction, can be implemented, for example, within a separate input processing IC or within the processing module 40 as necessary. Similarly, aspects of USB or HDMI interface processing can be implemented within separate interface ICs or within the processing module 40 as necessary. A demodulated, error corrected, and demultiplexed stream is provided to the processing module 40.

Various elements of system 4 can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system 4, the processing module 40 is interconnected to other elements of said system 4 by the bus 405.

The communication interface 404 of the processing module 40 allows the system 4 to communicate on a communication channel 41. The communication channel 41 can be implemented, for example, within a wired and/or a wireless medium.

Data is streamed, or otherwise provided, to the system 4, in various embodiments, using a wireless network such as a Wi-Fi network, for example IEEE 802.11 (IEEE refers to the Institute of Electrical and Electronics Engineers). The Wi-Fi signal of these embodiments is received over the communications channel 41 and the communications interface 404 which are adapted for Wi-Fi communications. The communications channel 41 of these embodiments is typically connected to an access point or router that provides access to external networks including the Internet for allowing streaming applications and other over-the-top communications. Other embodiments provide streamed data to the system 4 using a set-top box that delivers the data over the HDMI connection of the input block 42. Still other embodiments provide streamed data to the system 4 using the RF connection of the input block 42. As indicated above, various embodiments provide data in a non-streaming manner. Additionally, various embodiments use wireless networks other than Wi-Fi, for example a cellular network or a Bluetooth network.

The system 4 can provide an output signal to various output devices, including a display 46, speakers 47, and other peripheral devices 48. The display 46 of various embodiments includes one or more of, for example, a touchscreen display, an organic light-emitting diode (OLED) display, a curved display, and/or a foldable display. The display 46 can be for a television, a tablet, a laptop, a cell phone (smartphone), or other devices. The display 46 can also be integrated with other components (for example, as in a smartphone), or separate (for example, an external monitor for a laptop). The other peripheral devices 48 include, in various examples of embodiments, one or more of a stand-alone digital video disc (or digital versatile disc) (DVR, for both terms), a disk player, a stereo system, and/or a lighting system. Various embodiments use one or more peripheral devices 48 that provide a function based on the output of the system 4. For example, a disk player performs the function of playing the output of the system 4.

In various embodiments, control signals are communicated between the system 4 and the display 46, speakers 47, or other peripheral devices 48 using signaling such as AV.Link, Consumer Electronics Control (CEC), or other communications protocols that enable device-to-device control with or without user intervention. The output devices can be communicatively coupled to system 4 via dedicated connections through respective interfaces 43, 44, and 45. Alternatively, the output devices can be connected to system 4 using the communications channel 41 via the communications interface 404. The display 46 and speakers 47 can be integrated in a single unit with the other components of system 4 in an electronic device such as, for example, a television. In various embodiments, the display interface 43 includes a display driver, such as, for example, a timing controller (T Con) chip.

The display 46 and speaker 47 can alternatively be separate from one or more of the other components, for example, if the RF module of input block 42 is part of a separate set-top box. In various embodiments in which the display 46 and speakers 47 are external components, the output signal can be provided via dedicated output connections, including, for example, HDMI ports, USB ports, or COMP outputs.

Various implementations involve decoding. “Decoding”, as used in this application, can encompass all or part of the processes performed, for example, on a received encoded video stream in order to produce a final output suitable for display. In various embodiments, such processes include one or more of the processes typically performed by a decoder, for example, entropy decoding, inverse quantization, inverse transformation, and prediction. In various embodiments, such processes also, or alternatively, include processes performed by a decoder of various implementations or embodiments described in this application, for example, for determining a motion vector predictor for a coding unit encoding according to a merge mode.

As further examples, in one embodiment “decoding” refers only to entropy decoding (step 310 in FIG. 3). Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded video stream. In various embodiments, such processes include one or more of the processes typically performed by an encoder, for example, partitioning, prediction, transformation, quantization, and entropy encoding. In various embodiments, such processes also, or alternatively, include processes performed by an encoder of various implementations or embodiments described in this application, for example, for determining a motion vector predictor for a coding unit encoding according to a merge mode.

As further examples, in one embodiment “encoding” refers to the encoding mode selection (step 206 in FIG. 2) and entropy encoding (step 210 in FIG. 2). Whether the phrase “encoding process” is intended to refer specifically to a subset of operations or generally to the broader encoding process will be clear based on the context of the specific descriptions and is believed to be well understood by those skilled in the art.

Note that the syntax elements names, prediction modes name, tools name as used herein, are descriptive terms. As such, they do not preclude the use of other syntax element, prediction mode or tool names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between a rate and a distortion is usually considered. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of a reconstructed signal after coding and decoding. Faster approaches may also be used, to save encoding complexity, in particular with computation of an approximated distortion based on a prediction or a prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented, for example, in a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, inferring the information from other information(s), retrieving the information from memory or obtaining the information for example from another device, module or from user.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, inferring the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, inferring the information, or estimating the information.

It is to be appreciated that the use of any of the following “/”, “and/or”, and “at least one of”, “one or more of” for example, in the cases of “A/B”, “A and/or B” and “at least one of A and B”, “one or more of A and B” is intended to encompass the selection of the first listed option (A) only, or the selection of the second listed option (B) only, or the selection of both options (A and B). As a further example, in the cases of “A, B, and/or C” and “at least one of A, B, and C”, “one or more of A, B and C” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals syntax elements or parameters related to a motion vector predictor selected in a list of motion vector for a coding unit encoded in a merge mode. In this way, in an embodiment the same parameters are used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the encoded video stream of a described embodiment. Such a signal can be formatted, for example, as an electromagnetic wave (for example, using a radio frequency portion of spectrum) or as a baseband signal. The formatting can include, for example, encoding an encoded video stream and modulating a carrier with the encoded video stream. The information that the signal carries can be, for example, analog or digital information. The signal can be transmitted over a variety of different wired or wireless links, as is known. The signal can be stored on a processor-readable medium.

FIGS. 5 and 7 illustrated positions providing motion information allowing deriving respectively a temporal motion vector predictor (TMVP) and a sub-block temporal motion vector predictor (SbTMVP). FIG. 10 illustrates new positions allowing deriving a temporal motion vector predictor (TMVP) and a sub-block temporal motion vector predictor (SbTMVP). In FIG. 10, references A0, A1, B0, B1 and B2 represent positions around a current block (i.e. a current CU) of a current picture.

In an embodiment investigating positions used for deriving a new TMVP candidate (called displaced TMVP candidate), a process allows deriving a displaced TMVP candidate based on the positions illustrated in FIG. 10 as follows:
In a first step, the position A1 is tested. If a temporal motion vector predictor candidate can be extracted using A1, i.e. if a first motion vector is available at position A1 and if a second motion vector is available at a position in the reference picture of the current picture corresponding to the position of the center of the current block displaced of the value of the first motion vector at position A1, the second motion vector is the displaced TMVP candidate of the current block.
If not, in a second step, the position B1 is tested. If a temporal motion vector candidate can be extracted using B1, i.e. if a first motion vector is available at position B1 and if a second motion vector is available at a position in the reference picture of the current picture corresponding to the position of the center of the current block displaced of the value of the first motion vector at position B1, the second motion vector is the displaced TMVP candidate of the block.
If not, in a third step, the null vector is used. If a temporal motion vector candidate can be extracted using the null vector (if a motion vector is available at a position in the reference picture of the current picture corresponding to the position of the center of the current block), the available motion vector is the displaced TMVP candidate of the block.

In a first variant of the embodiment investigating positions used for deriving a displaced TMVP candidate, the found displaced TMVP candidate is added to the list of merge candidates in replacement of the default TMVP candidate. If no displaced TMVP candidate is found, then the default TMVP candidate is added, if found. Note that the TMVP candidate using the position C in FIG. 5 is similar to the motion vector obtained in the third step.

Alternatively, if the displaced candidate is similar to the default TMVP candidate, then only the TMVP is kept in the list.

In a second variant of the embodiment investigating positions used for deriving a displaced TMVP candidate, more positions are tested than A1, B1 and the center position, by testing successively, for example, the positions A1, B1, B0, A0, B2, H and the null vector.

In third variant of the embodiment investigating positions used for deriving a displaced TMVP candidate, the same process as above is used to derive the motion vector used for the SbTMVP process. In other words, the process of the embodiment investigating positions used for deriving the displaced TMVP candidate is used to determine the motion shift (i.e. the displacement) in the first step of the two steps SbTMVP process described in relation to FIGS. 7 and 8.

In a fourth variant of the embodiment investigating positions used for deriving a displaced TMVP candidate, the found displaced TMVP candidate is added to the list of merge candidates in addition to the default TMVP candidate.

In an embodiment related to AMVP, a displaced TMVP candidate, for example obtained by the embodiment investigating positions used for deriving the displaced TMVP candidate described in relation to FIG. 10 (or one of its four variants), is used as a new temporal candidate for AMVP. When used in AMVP, the following changes are applied to the displaced TMVP candidate:
the number of reference picture lists is the number of AMVP reference lists decoded, instead of using both reference lists list-0 and list-1 for B-slice as in the default process.
the reference index is determined depending on a AMVP reference index decoded, instead of using reference index “0” as in the default process.

The embodiment described in relation to FIG. 10 (and its four variants) allows identifying a new TMVP candidate. In the following, several embodiments are proposed to increase the number of TMVP candidates, for example, to be used in the list of candidates of the merge mode.

### Uni-Directional Motion Vector Candidate

A list of motion vector candidates can comprise bi-prediction candidates (i.e. candidates comprising motion information corresponding to list list-0 and motion information corresponding to list list-1). In an embodiment, new candidates can be defined from a bi-prediction candidate by discarding either the motion information corresponding to list list-0 or the motion information corresponding to list list-1 and adding the resulting motion vector predictor to the list of candidates. The new candidate is therefore a uni-prediction candidate.

### Symmetric Temporal Motion Vector Predictor Candidates

In an embodiment, the TMVP candidate is replaced by a symmetric version of the TMVP candidate when possible in the merge list of motion vector predictors.

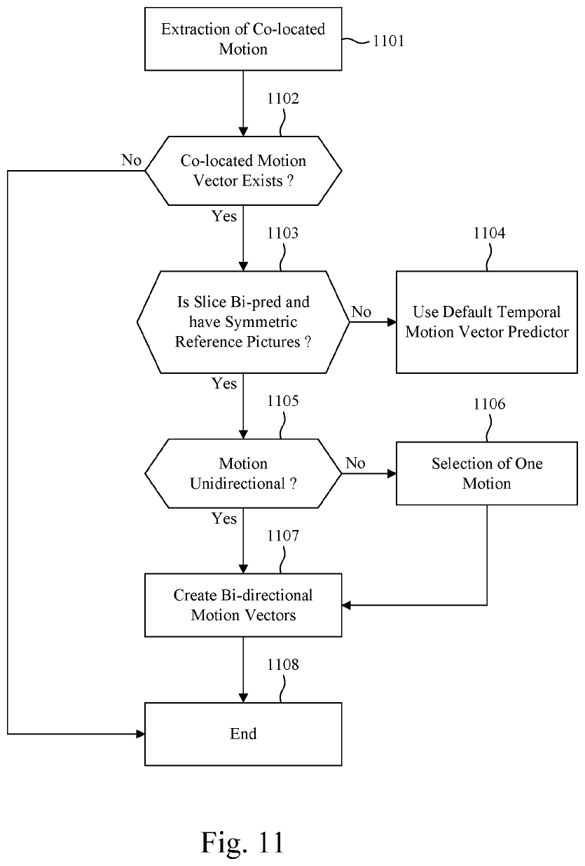

FIG. 11 illustrates a process allowing defining symmetric temporal motion vector candidates for a current block. The process of FIG. 11 is for example implemented by the processing module 40 when this processing module implements steps 204 or 208 of the encoding process of FIG. 2 or when the processing module 40 implements steps 308 or 316 of the decoding process of FIG. 3.

In a step 1101, the processing module 40 determines a regular temporal motion vector predictor (RTMVP) for the current block as described above in relation to FIG. 5. In the process described in relation to FIG. 5, only positions H and C are tested but, for step 1101, other or additional positions could be tested such as at least one of positions A0, A1, B0, B1 and/or B2.

In a step 1102, if no RTMVP was determined in step 1101, the processing module 40 stops the process of FIG. 11 in a step 1108. Otherwise, the processing module 40 continues with step 1103.

In step 1103, the processing module 40 determines if a slice comprising the current block (i.e. the current slice) is a bi-prediction slice and if symmetrical reference pictures exist in lists list-0 and list-1. If the current slice is a bi-prediction slice and symmetrical reference pictures exist in lists list-0 and list-1, a symmetric temporal motion vector predictor (Symmetric TMVP) candidate is constructed with steps 1105 to 1107. One can note that symmetrical reference pictures are called ref0 (for the reference picture of list list-0) and ref1 (for the reference picture of list list-1) and are symmetrically in the past and the future of the current picture comprising the current block. Otherwise, the RTMVP derived in step 1101 is inserted in the merge list of candidates in step 1104. In other words, the RTMVP derived in step 1101 is used as a default TMVP candidate if no other TMVP candidate can be found.

In step 1105, the processing module 40 determines if the RTMVP is unidirectional. If the RTMVP is unidirectional, the RTMVP is selected as a motion to be rescaled in step 1107. In that case the variables cmv and cref denotes respectively the motion vector and the reference picture index associated to the RTMVP. Otherwise, if the RTMVP is bidirectional, in step 1106, the following sub-steps are applied by the processing module 40:
the POC (picture Order Count) of the current picture is denoted cPOC;
the POC of the reference picture corresponding to the reference index in list list-0 of the RTMVP is denoted cPOC0;
the POC of the reference picture corresponding to the reference index in list list-1 of the RTMVP is denoted cPOC1;
If abs(cPOC-cPOC0)<abs(cPOC-cPOC1) then the motion of the RTMVP corresponding to list list-0 is selected for rescaling. Otherwise the motion of the RTMVP corresponding to list list-1 is selected.

In step 1107, the motion selected either in step 1106 or directly in step 1105 is first, rescaled to point to the reference picture ref0 in list list-0 and second, rescaled to point to the reference picture ref1 in list list-1. In step 1107, the rescaling process detailed in relation to FIG. 6 is applied. The two rescaled motion vectors form a symmetric temporal motion vector predictor (i.e. symmetric TMVP) candidate.

Step 1107 is followed by step 1108.

### Symmetric Sub-Block Temporal Motion Vector Predictor Candidates

In a embodiment, a process similar to the process applied to determine a symmetric TMVP candidate is applied in the context of SbTMVP.

In this embodiment, the first step of the process of SbTMVP described in relation to FIGS. 7 and 8 is applied to determine a motion shift.

The motion shift is then applied to the current block and a step similar to step 1101 is applied. In this step, the processing module 40 determines a temporal motion vector predictor (TMVP) for the current block but this time using positions in or around the shifted position of the current block. In an embodiment, only positions H and C are tested but, in some variants other or additional positions could be tested such as at least one of positions A0, A1, B0, B1 and/or B2. If no TMVP can be determined for the current block, the process stops. Otherwise, the found TMVP becomes a default TMVP.

Steps 1102 to 1108 described in relation to FIG. 11 are then applied to determine a symmetric TMVP candidate for each sub-block of the current block. If, for one sub-block, no symmetric TMVP candidate can be derived, the default TVMP is used as the motion vector predictor candidate for this sub-block by applying step 1103.

### Advanced Motion Vector Prediction (AMVP) Temporal Candidate Improvement

In AMVP mode, the reference list and the reference picture index inside this list are signaled (as opposed to deduced in the merge mode).

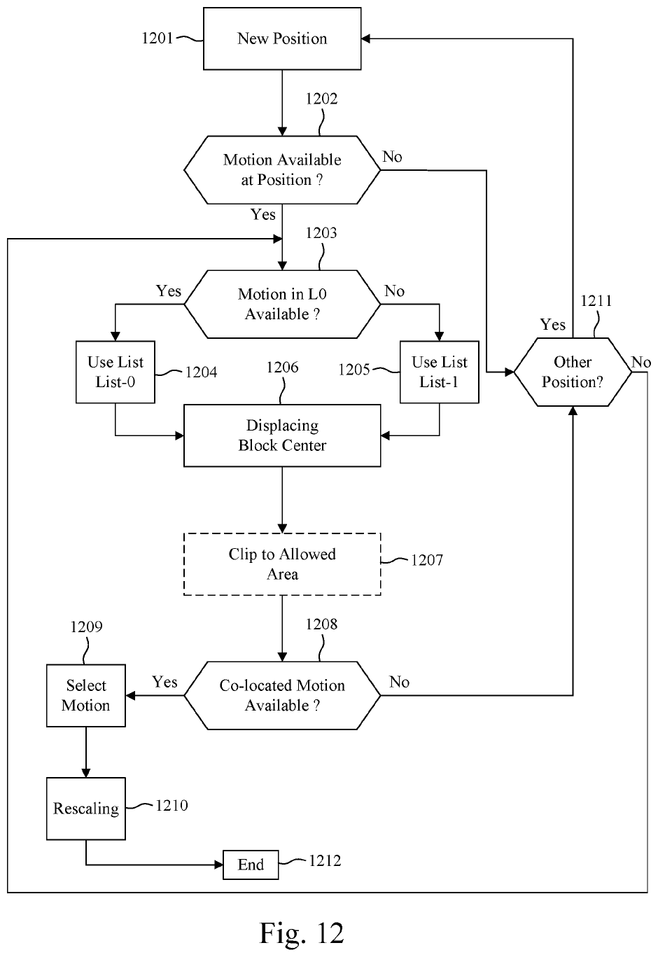

FIG. 12 illustrates schematically a process for improving a temporal candidate for AMVP.

In order to create a displaced AMVP candidate, a motion shift is derived from initial positions, similarly to the process described in relation to FIG. 10 when applied to SbTMVP.

In a step 1201, the processing module 40 obtains a new position in a list of positions comprising for, example positions, A1 and B1 in FIG. 10.

In a step 1202, the processing module 40 determines if a motion is available at the tested position. If a motion is available at the tested position, step 1202 is followed by step 1203.

If no motion is available at the tested position, the processing module 40 determines if at least one other position remains to be tested in the list of positions in a step 1211. If yes, the processing module 40 applies again step 1201. Otherwise, the processing module 40 uses the null vector and step 1211 is followed by step 1203.

In step 1203, the processing module 40 determines if a motion pointing on a reference picture of list list-0 is available.

If a motion pointing on a reference picture of list list-0 is available, the processing module 40 uses this motion in step 1204. Otherwise, the processing module 40 uses a motion pointing on a reference picture of list list-1 in a step 1205.

Steps 1204 and 1205 are both followed by a step 1206. In step 1206, the processing module 40, the processing module 40 displaces the center of the current block (i.e. of the current PU) of a displacement corresponding to the motion determined in steps 1204 or 1205.

In a step 1208, the processing module 40 determines if a motion vector is available in the co-located picture at the position of the displaced center.

If no motion is available in the co-located picture at the position of the displaced center, the processing module 40 returns to step 1211.

If a motion is available in the co-located picture at the position of the displaced center, the processing module selects this motion in a step 1209.

In a step 1210, the processing module 40 rescales the selected motion vector to ensure that this motion vector points to the current reference picture (i.e. to the reference picture in first position in the reference picture buffer) by applying the process of FIG. 6.

The process ends in a step 1212. The rescaled motion vector obtained in step 1210 is used as a TMVP candidate for AMVP. If no motion vector is available in the co-located picture at the position of the displaced center in step 1208 when the null vector, the processing module 40 use the regular TMVP candidate of AMVP.

Optionally, the process of FIG. 12 comprises a step 1207 between steps 1206 and 1208. In step 1207, the processing module 40 clips the displacement of the center of the current block (i.e. of the current PU) specified by the motion determined in steps 1204 or 1205 in a predefined area around the center of the current block. For example, the predefined area is a square of 32×32 pixels centered on the center of the current block. In a variant, if the displacement displaces the center of the current block outside of the predefined area, this displacement is rejected and the processing module 40 goes back to step 1211.

### Closest Picture Order Count Candidate

In an embodiment, as an alternate candidate to the default (i.e. regular) AMVP TMVP candidate, a candidate with better motion accuracy is chosen as a TMVP candidate.

The first part of the process is the same as in the default temporal candidate for AMVP: positions C or H in FIG. 5 are examined to extract motion information.

In the default process of AMVP, the motion vector corresponding to list list-i is extracted. If not available, the motion vector corresponding to the other list is extracted. In the proposed embodiment, when the motion vector corresponding to list list-0 and the motion vector corresponding to list list-1 are available, an additional process is performed. The additional process consists in selecting either the motion vector corresponding to list list-0 or the motion vector corresponding to list list-1. In a first variant, the additional process consists in selecting the smallest motion vector between the motion vector corresponding to list list-0 or the motion vector corresponding to list list-1. In a second variant, in the additional process, the motion vector pointing to a reference picture the closest to the current picture in terms of POC (Picture Order Count) is selected as the motion vector to rescale, using the same process as the one described in step 1106. After the motion vector selection, the processing module 40 rescales the selected motion vector to ensure that this motion vector points to the current reference picture (i.e. to the reference picture in first position in the reference picture buffer) applying the process of FIG. 6.

### Projected Buffer

In embodiment, in order to obtain better displaced TMVP candidates, an alternative is to create a buffer of projected motion vectors. This buffer is typically created at the beginning of the decoding of each picture.

The process to create the projected buffer is similar to the process applied to obtain the interpolated motion field described in document Algorithm Description of Joint Exploration Test Model 6 (JEM 6)″ JVET-F1001, section 2.3.7.3 available at https://jvet-experts.org/doc_end_user/documents/6_Hobart/wg11/JVET-F1001-v2.zip but the following changes are applied:
Only the motion field of the co-located picture is traversed at 4×4 block level.
For each vector in the co-located picture, the motion vector of the block in the current picture where is passing the motion vector of the co-located picture is rescaled to have a reference picture in the past and a reference picture in the future at equal distance of the current picture, using a process consisting in identifying a couple of a past picture and a future picture that are symmetric with respect to the current picture and that both minimize a difference picture order count (POC) with respect to the current image. In a first variant, the process consists in identifying a couple of a past picture and a future picture that both minimize a difference picture order count (POC) with respect to the current image. In a second variant, the process consists in decoding the reference indices of the past and future frame, the encoder signaling these indices.
Optionally, if the motion vector of the block in the current picture where is passing the motion vector of the collocated picture is unidirectional, a symmetric bi-prediction motion vector is created (following the process of the Symmetric temporal motion vector predictor candidates explained before).

The obtained rescaled motion vector is assigned to a block of the projected buffer co-localized with the current block.

In a first variant of the embodiment based on the projected buffer, for the merge mode or the AMVP mode, a displaced TMVP candidate is extracted from the co-located block of the current block of the projected buffer.

The position C with respect to the co-located block of the projected buffer is tested. If valid motion information can be found at this position, this motion information becomes a candidate. Otherwise, the position B1 is tested. In no valid motion information is found at position B1, no candidate obtained from the projected buffer is used. Alternatively, more positions (H, A1, A, B1, B0) are also tested until valid motion information is found.

If a candidate was found, the candidate is used in place or in addition to the TMVP or displaced TMVP respectively for AMVP or merge.

In a second variant of the embodiment based on the projected buffer, the motion field of the projected buffer can also be used to identify the SbTMVP candidates. In this case, for each sub-block in the current block, the motion vector of the projected buffer co-located with the displaced current block is selected as a candidate for the sub-block, if it exists. Otherwise, the candidate for the sub-block is set to a default candidate. In an embodiment, the default candidate is the candidate provided by the first variant of the embodiment based on the projected buffer.

In a third variant of the embodiment based on the projected buffer, in case of affine candidate, several affine model can be derived directly from the corners motion vectors (Control Point Motion Vector CPMV) in the collocated block in the projected buffer. The model derivation process is the same as the constructed affine model in VVC but reference POC is guaranteed to be the same for each CPMV, giving a consistent affine model. As in the constructed affine model process, two or more motion vectors are taken at the corner of the block and are used as CPMV to derive an affine model with four or more parameters.

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

Various methods are described herein, and each of the methods comprises one or more steps or actions for achieving the described method. Unless a specific order of steps or actions is required for proper operation of the method, the order and/or use of specific steps and/or actions may be modified or combined.

Various methods and other aspects described in this application can be used to modify modules, for example, the motion vector coding step 208 of a video encoder and or the motion vector decoding step 308 of a decoder. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values, various positions and/or various constrained areas are used in the present application. The specific values, positions, constrained areas are for example purposes and the aspects described are not limited to these specific values, positions and constrained areas.

Further, embodiments can include one or more of the following features, devices, or aspects, alone or in any combination, across various claim categories and types:
Inserting in a signaling syntax elements that enable the decoder to identify the motion vector prediction method to use;
A bitstream or signal that includes syntax conveying information generated according to any of the embodiments described;
Inserting in the signaling syntax elements that enable the decoder to adapt motion vector prediction in a manner corresponding to that used by an encoder;
Creating and/or transmitting and/or receiving and/or decoding a bitstream or signal that includes one or more of the described syntax elements, or variations thereof;
A method, process, apparatus, medium storing instructions, medium storing data, or signal according to any of the embodiments described;
A TV, set-top box, cell phone, tablet, or other electronic device that performs motion vector prediction according to any of the embodiments described;
A TV, set-top box, cell phone, tablet, or other electronic device that performs motion vector prediction according to any of the embodiments described, and that displays (e.g. using a monitor, screen, or other type of display) a resulting image;
A TV, set-top box, cell phone, tablet, or other electronic device that selects (e.g. using a tuner) a channel to receive a signal including an encoded image, and performs motion vector prediction according to any of the embodiments described;
A TV, set-top box, cell phone, tablet, or other electronic device that receives (e.g. using an antenna) a signal over the air that includes an encoded image, and performs motion vector prediction according to any of the embodiments described.

1. A method for decoding, the method comprising:
obtaining an ordered list of a plurality of positions in a spatial neighborhood of a current block in a picture;
parsing the ordered list in order until first motion information is available at one of the plurality of positions and second motion information is available at a position in a reference picture designated by the first motion information; and
using the second motion information to obtain at least one motion vector predictor candidate to be inserted in at least one list of motion vector predictor candidates used for predicting a motion vector used for the current block.

2. (canceled)

3. The method of claim 1, wherein the ordered list of a plurality of positions comprises at least two positions among:
a first position (A0) at a bottom left corner of the current block;
a second position (A1) at a bottom left corner of the current block above the first position;
a third position (B0) at an upper right corner of the current block;
a fourth position (B1) at an upper right corner of the current block on the left of the fourth position;
a fifth position (B2) at an upper left corner of the current block; and
a sixth position (H) at a bottom right corner of the current block.

4. The method of claim 23 wherein the second position is before the fourth position in the ordered list of a plurality of positions.

5. The method according to claim 1, 2, 3 or 4 wherein the second motion information is used to obtain one motion vector predictor candidate to be inserted in one list of motion vector predictor candidates for predicting a motion vector of the current block for the-a merge mode or for the Advanced Motion Vector Prediction an advanced motion vector prediction mode.

6. The method according to claim 1, wherein the second motion information is used to determine a displacement to be applied to a position of the current block to obtain a motion vector predictor candidate from the reference picture for each sub-block of the current block, the motion vector predictor candidate of a sub-block being inserted in a list of motion vector predictor candidates of the sub-block used for predicting a motion vector of the sub-block.

7. The method according to claim 1, wherein if one motion vector predictor candidate of one of the at least one list of motion vector predictor candidates used for predicting a motion vector used for the current block is a bi-prediction candidate, the method comprises discarding either a motion information of this candidate corresponding to a first list of reference pictures or a motion information of this candidate corresponding to a second list of reference pictures and inserting a candidate resulting from this discarding in the list of motion vector predictor candidates.

8. The method according to claim 1, comprising:
using at least one position of the ordered list of a plurality of positions to extract a third motion information from the reference picture;
deriving a symmetric motion vector predictor from the third motion information, the symmetric motion vector predictor having a first motion vector pointing on a first reference picture and a second motion vector pointing on a second reference picture, the first reference picture and the second reference picture being symmetric with respect to the picture comprising the current block, a sum of the first and the second motion vectors being null; and
inserting the derived symmetric motion vector predictor in the list of motion vector predictor candidates for the current block.

9. The method according to claim 1, comprising:
displacing the current block from a displacement depending on a motion information obtained from one position of the ordered list of a plurality of positions;
dividing the displaced current block and a co-located block of the reference picture in sub-blocks and for at least one sub-block of the displaced current block;
deriving a symmetric motion vector predictor from a motion information of a co-located sub-block of the reference picture, the symmetric motion vector predictor having a first motion vector pointing on a first reference picture and a second motion vector pointing on a second reference picture, the first reference picture and the second reference picture being symmetric with respect to the picture comprising the current block, a sum of the first and the second motion vectors being null; and
inserting the derived symmetric motion vector predictor in the list of motion vector predictor candidates for the sub-block.

10. The method according to claim 1, wherein using the second motion information to obtain at least one motion vector predictor candidate to be inserted in at least one list of motion vector predictor candidates used for predicting a motion vector used for the current block comprises, responsive to the second motion information comprising first motion data related to a first list of reference pictures and second motion data related to a second list of reference pictures, using either the first motion data or the second motion data to obtain at least one motion vector predictor candidate to be inserted in at least one list of motion vector predictor candidates used for predicting a motion vector used for the current block.

11. The method according to claim 10, wherein the first motion data designates a second reference picture and the second motion data designates a third reference picture and the motion data among the first motion data and the second motion data designating the reference picture among the first reference picture and the second reference picture the closest to the picture comprising the current block in terms of picture order count is used.

12. (canceled)

13. A device for decoding, the device comprising electronic circuitry configured for:
obtaining an ordered list of a plurality of positions in a spatial neighborhood of a current block in a picture;
parsing the ordered list in order until first motion information is available at one of the plurality of positions and second motion information is available at a position in a reference picture designated by the first motion information; and
using the second motion information to obtain at least one motion vector predictor candidate to be inserted in at least one list of motion vector predictor candidates used for predicting a motion vector used for the current block.

14. A device for coding, the device comprising electronic circuitry configured for:
obtaining an ordered list of a plurality of positions in a spatial neighborhood of a current block in a picture;
parsing the ordered list in order until first motion information is available at one of the plurality of positions and second motion information is available at a position in a reference picture designated by the first motion information; and
using the second motion information to obtain at least one motion vector predictor candidate to be inserted in at least one list of motion vector predictor candidates used for predicting a motion vector used for the current block.

15-27. (canceled)

28. A method for coding, the method comprising:
obtaining an ordered list of a plurality of positions in a spatial neighborhood of a current block in a picture;
parsing the ordered list in order until first motion information is available at one of the plurality of positions and second motion information is available at a position in a reference picture designated by the first motion information; and
using the second motion information to obtain at least one motion vector predictor candidate to be inserted in at least one list of motion vector predictor candidates used for predicting a motion vector used for the current block.

29. The method of claim 28, wherein the ordered list of a plurality of positions comprises at least two positions among:
a first position (A0) at a bottom left corner of the current block;
a second position (A1) at a bottom left corner of the current block above the first position;
a third position (B0) at an upper right corner of the current block;
a fourth position (B1) at an upper right corner of the current block on the left of the fourth position;
a fifth position (B2) at an upper left corner of the current block; and
a sixth position (H) at a bottom right corner of the current block.

30. The method of claim 29, wherein the second position is before the fourth position in the ordered list of a plurality of positions.

31. The method according to claim 28, wherein the second motion information is used to obtain one motion vector predictor candidate to be inserted in one list of motion vector predictor candidates for predicting a motion vector of the current block for the merge mode or for the advanced motion vector prediction mode.

32. The method according to claim 28, wherein the second motion information is used to determine a displacement to be applied to a position of the current block to obtain a motion vector predictor candidate from the reference picture for each sub-block of the current block, the motion vector predictor candidate of a sub-block being inserted in a list of motion vector predictor candidates of the sub-block used for predicting a motion vector of the sub-block.

33. The method according to claim 28, wherein if one motion vector predictor candidate of one of the at least one list of motion vector predictor candidates used for predicting a motion vector used for the current block is a bi-prediction candidate, the method comprises discarding either a motion information of this candidate corresponding to a first list of reference pictures or a motion information of this candidate corresponding to a second list of reference pictures and inserting a candidate resulting from this discarding in the list of motion vector predictor candidates.

34. The method according to claim 28, comprising:
using at least one position of the ordered list of a plurality of positions to extract a third motion information from the reference picture;
deriving a symmetric motion vector predictor from the third motion information, the symmetric motion vector predictor having a first motion vector pointing on a first reference picture and a second motion vector pointing on a second reference picture, the first reference picture and the second reference picture being symmetric with respect to the picture comprising the current block, a sum of the first and the second motion vectors being null; and
inserting the derived symmetric motion vector predictor in the list of motion vector predictor candidates for the current block.

35. The method according to claim 28, comprising:
displacing the current block from a displacement depending on a motion information obtained from one position of the ordered list of a plurality of positions;
dividing the displaced current block and a co-located block of the reference picture in sub-blocks and for at least one sub-block of the displaced current block;
deriving a symmetric motion vector predictor from a motion information of a co-located sub-block of the reference picture, the symmetric motion vector predictor having a first motion vector pointing on a first reference picture and a second motion vector pointing on a second reference picture, the first reference picture and the second reference picture being symmetric with respect to the picture comprising the current block, a sum of the first and the second motion vectors being null; and
inserting the derived symmetric motion vector predictor in the list of motion vector predictor candidates for the sub-block.
